(19) United States
(12) Patent Application Publication
(10) Pub. No.: US 2008/0245726 A1
(43) Pub. Date: Oct. 9, 2008

(54) Closed-Loop-Bonded Filter Media and Liner Pleat Block and Method

(76) Inventor: Michael J. Senetar, Madison, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/696,758

(22) Filed: Apr. 5, 2007

(51) Int. Cl. B01D 29/07

(52) U.S. Cl. 210/487; 156/155; 156/69; 156/73.1; 210/493.1; 210/493.2

(57) ABSTRACT

A filter media and liner pleat block and method involves melting the filter media at mating pleats to form a closed-loop-bonded filter media and liner pleat block.

### BACKGROUND AND SUMMARY

The invention relates to filter media and liner pleat blocks.

Filter media and liner pleat blocks are known in the prior art. A layer of filter media and a mesh screen liner are pleated along axially extending pleat bend lines and wrapped in a closed loop. The pleat block extends axially along the axially extending pleat bend lines between distally opposite first and second axial ends, which axial ends may be embedded in respective first and second axial end caps to provide a filter element. When the filter media and mesh screen liner are initially wrapped around a closed loop to mating pleats, such mating pleats must be secured to each other or otherwise held in place during the noted imbedding of the axial ends in the axial end caps. The mating pleats must also be sealed to each other, to maintain filter integrity and prevent a bypass or leakage path for unfiltered fluid.

The present invention arose during development efforts directed toward simplified filter media and liner pleat blocks and manufacturing methods, including maintaining filter integrity.

### BRIEF DESCRIPTION OF THE DRAWINGS

FIG. 1 is a perspective view of a filter element including a filter media and liner pleat block in accordance with the invention.

FIG. 2 is an enlarged view of a portion of FIG. 1.

FIG. 3 is a sectional view taken along line 3-3 of FIG. 2.

FIG. 4 is a view like FIG. 3 but showing an earlier manufacturing step.

FIG. 5 is a sectional view taken along line 5-5 of FIG. 3.

FIG. 6 is like FIG. 3 and shows an alternate embodiment.

FIG. 7 is a sectional view taken along line 7-7 of FIG. 6.

### DETAILED DESCRIPTION

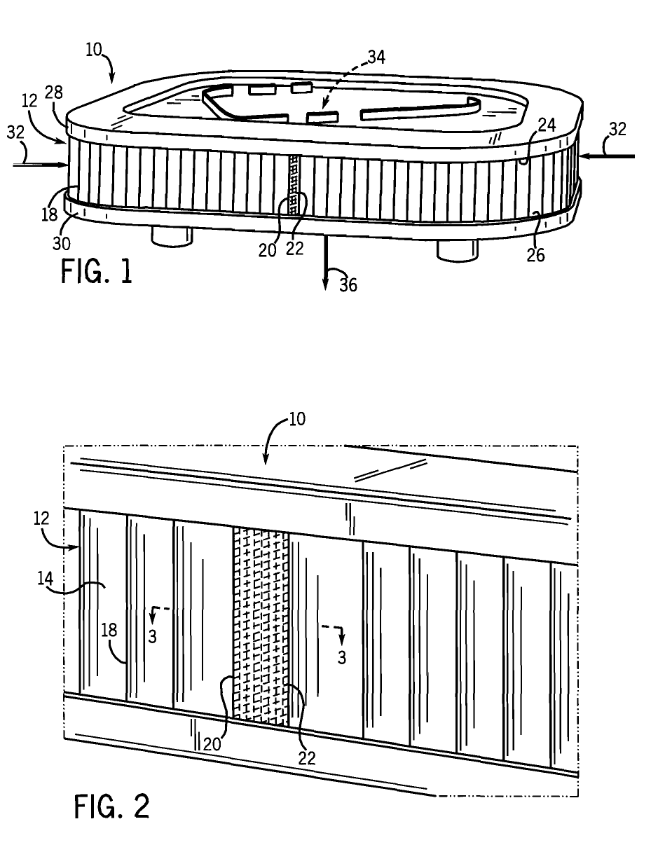

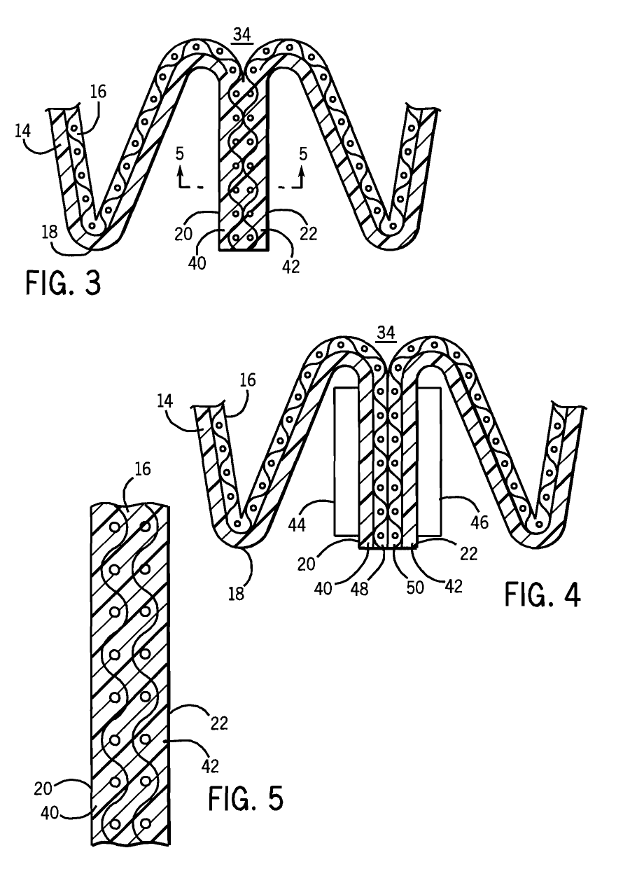

FIG. 1 shows a filter element 10 including a filter media and liner pleat block 12 which is composed of one or more layers of filter media 14, FIGS. 2, 3, and a mesh screen liner 16 pleated along axially extending pleat bend lines 18 and wrapped around a closed loop to mating pleats 20 and 22, FIGS. 1-3. The axially extending bend lines 18 extend up-down in FIGS. 1, 2, and extend into and out of the page in FIG. 3. The pleat block extends axially along the noted axially extending bend lines 18 between distally opposite first and second axial ends 24 and 26, which axial ends are embedded in respective first and second axial end caps 28 and 30 to form filter element 10. Fluid to be filtered, e.g. air, liquid, etc., flows laterally inwardly as shown at arrows 32 through the filter media into the hollow interior 34 within the noted closed loop, and then flows axially downwardly as shown at arrow 34 as clean filtered fluid to the protected component, e.g. an internal combustion engine, or some other component to which clean filtered fluid is to be directed. Mating pleats 20 and 22 must be secured to each other during embedding of axial ends 24 and 26 in end caps 28 and 30, as is known. Furthermore, mating pleats 20 and 22 must be sealed to each other, to maintain filter integrity, and prevent leakage of unfiltered dirty fluid into hollow interior 34. Various systems, including clips, have been used in the past to hold mating pleats 20 and 22 in place during the noted embedding, and to maintain a seal therebetween for filter integrity. The present invention provides an improved system therefor.

The preferred embodiment of the present method involves melting the filter media 14 at mating pleats 20 and 22 to form a closed-loop-bonded filter media and liner pleat block. The filter media is melted at mating pleats 20 and 22 to flow into the mesh screen liner, FIG. 3, such that filter media 40 from mating pleat 20 melts and flows into the mesh screen liner and bonds to filter media 42 from the other mating pleat 22 melting and flowing into the mesh screen liner. In the preferred embodiment, the mesh screen liner 16 is an inner liner on the interior of the closed loop and facing hollow interior 34, and the filter media 14 is on the exterior of the closed loop.

The preferred method involves ultrasonically welding the filter media along the exterior of the closed loop at mating pleats 20 and 22. A pair of ultrasonic welding heads 44 and 46, FIG. 4, are disposed on distally opposite sides of mating pleats 20 and 22. The filter media at 40 and 42 is located between and provides cushioning between a respective ultrasonic welding head and mesh screen liner. The filter media is ultrasonically welded to itself through the mesh screen liner. In one embodiment, the filter media is polyester bonded to a metallic mesh screen liner, e.g. adhesively or otherwise. This holds the filter media and liner together and provides laminated media, which laminated media is then wrapped around a closed loop to the noted mating pleats 20 and 22 which are then bonded by ultrasonic welding between ultrasonic welding heads 44 and 46 to form the noted closed-loop-bonded filter media and liner pleat block. The filter media at mating pleats 20 and 22 is ultrasonically welded to itself through the mesh screen liner by melting the filter media at the mating pleats to flow into the mesh screen liner such that the filter media from mating pleat 20 melts and flows into the mesh screen liner and bonds to filter media from mating pleat 22 melting and flowing into the mesh screen liner.

The mesh screen liner is provided as at least one and preferably two layers 48 and 50 between mating pleats 20 and 22. In the preferred double layer version, mesh screen liner 16 extends all the way along media 14 such that upon wrapping around a closed loop, a double layer mesh screen liner thickness is provided, namely a first layer 48 of mesh screen liner 16 along mating pleat 20, and a second layer 50 of mesh screen liner 16 along the other mating pleat 22. In the single thickness mesh screen liner version at the mating pleats, a portion of the mesh screen liner 16 is omitted at one of the mating pleats such that upon wrapping around a closed loop, only a single layer of the mesh screen liner extends between mating pleats 20 and 22.

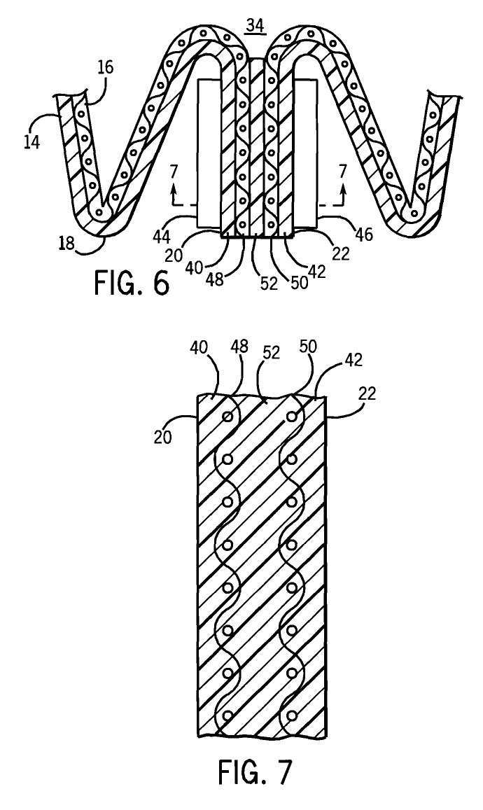

FIGS. 6 and 7 show an alternate embodiment and use like reference numerals from above where appropriate to facilitate understanding. An extra strip of material 52, preferably an extra strip of filter media, is provided between first and second layers 48 and 50 of mesh screen liner 16. The method involves melting the extra strip of filter media material 52 during melting of the filter media 40, 42 of mating pleats 20, 22 such that the filter media 40 of mating pleat 20 is bonded to filter media 42 of mating pleat 22 by the extra strip of melted and bonded filter media material 52 therebetween.

The present system provides a filter media and liner pleat block 12 including a layer of filter media 14 and a mesh screen liner 16 pleated along axially extending pleat bend lines 18 and wrapped around a closed loop to mating pleats 20 and 22. The filter media has melted portions 40, 42 at the mating pleats 20, 22 to form a closed-loop-bonded filter media and liner pleat block. The melted portions 40, 42 of the filter media are embedded in and re-solidified in the mesh screen liner such that filter media 40 at mating pleat 20 has melted and re-solidified portions in the mesh screen liner bonded to melted and re-solidified filter media portions 42 from the other mating pleat 22 in the mesh screen liner. The filter media is ultrasonically welded to itself through the mesh screen liner at the melted and re-solidified portions 40, 42. An extra layer of material 52, FIG. 6, preferably filter media material, may be provided between first and second layers 48 and 50 of the mesh screen liner, with the extra strip of material 52 being melted and bonded to the filter media of the mating pleats 20 and 22 such that filter media 40 of mating pleat 20 is bonded to filter media 42 of mating pleat 22 by the noted extra strip of material 52 therebetween.

In the foregoing description, certain terms have been used for brevity, clearness, and understanding. No unnecessary limitations are to be implied therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims.

What is claimed is:

1. A method of making a filter media and liner pleat block, comprising providing a layer of filter media and a mesh screen liner pleated along axially extending pleat bend lines and wrapped around a closed loop to mating pleats, melting said filter media at said mating pleats to form a closed-loop-bonded said filter media and liner pleat block.

2. The method according to claim 1 comprising melting said filter media at said mating pleats to flow into said mesh screen liner such that filter media from one of said mating pleats melts and flows into said mesh screen liner and bonds to filter media from the other of said mating pleats melting and flowing into said mesh screen liner.

3. The method according to claim 1 wherein said closed loop defines a hollow interior, said mesh screen liner is an inner liner on the interior of said closed loop and facing said hollow interior, said filter media is on the exterior of said closed loop.

4. The method according to claim 3 comprising ultrasonically welding said filter media along said exterior of said closed loop at said mating pleats.

5. The method according to claim 4 comprising:
disposing a pair of ultrasonic welding heads on distally opposite sides of said mating pleats, with said filter media located between and providing cushioning between a respective said ultrasonic welding head and said mesh screen liner; and
ultrasonically welding said filter media to itself through said mesh screen liner.

6. The method according to claim 1 wherein said filter media is polyester bonded to a metallic said mesh screen liner.

7. The method according to claim 1 wherein said pleat block extends axially along said axially extending pleat bend lines between first and second axial ends, and comprising embedding said first and second axial ends in respective first and second axial end caps to provide a filter element.

8. The method according to claim 1 wherein said closed loop defines a hollow interior, said mesh screen liner is an inner liner on the interior of said closed loop and facing said hollow interior, said filter media is on the exterior of said closed loop, and comprising ultrasonically welding said filter media along said exterior of said closed loop at said mating pleats by disposing a pair of ultrasonic welding heads on distally opposite sides of said mating pleats, with said filter media located between and providing cushioning between a respective said ultrasonic welding head and said mesh screen liner, and ultrasonically welding said filter media to itself through said mesh screen liner by melting said filter media at said mating pleats to flow into said mesh screen liner such that filter media from one of said mating pleats melts and flows into said mesh screen liner and bonds to filter media from the other of said mating pleats melting and flowing into said mesh screen liner.

9. The method according to claim 2 comprising providing said mesh screen liner as at least one layer between said mating pleats.

10. The method according to claim 2 comprising providing said mesh screen liner as two layers between said mating pleats, namely a first layer of said mesh screen liner along said one of said mating pleats, and a second layer of said mesh screen liner along said other of said mating pleats.

11. The method according to claim 10 comprising providing an extra strip of material between said first and second layers of mesh screen liner, and melting said extra strip of material during said melting of said filter media of said one and said other of said mating pleats such that said filter media of said one of said mating pleats is bonded to said filter media of said other of said mating pleats by said extra strip of material therebetween.

12. The method according to claim 11 wherein said extra strip of material is an extra strip of filter media.

13. A filter media and a liner pleat block made by the method of claim 1.

14. A filter media and liner pleat block comprising a layer of filter media and a mesh screen liner pleated along axially extending pleat bend lines and wrapped around a closed loop to mating pleats, said filter media having melted portions at said mating pleats to form a closed-loop-bonded said filter media and liner pleat block.

15. The filter media and liner pleat block according to claim 14 wherein said melted portions of said filter media are embedded in and re-solidified in said mesh screen liner such that said filter media at one of said mating pleats has melted and re-solidified portions in said mesh screen liner bonded to melted and re-solidified filter media portions from the other of said mating pleats in said mesh screen liner.

16. The filter media and liner pleat block according to claim 14 wherein said closed loop defines a hollow interior, said mesh screen liner is an inner liner on the interior of said closed loop and facing said hollow interior, and said filter media is on the exterior of said closed loop.

17. The filter media and liner pleat block according to claim 14 wherein said filter media is ultrasonically welded to itself through said mesh screen liner at said melted and re-solidified portions.

18. The filter media and liner pleat block according to claim 14 wherein said filter media is polyester bonded to a metallic said mesh screen liner.

19. The filter media and liner pleat block according to claim 15 wherein said pleat block extends axially along said axially extending pleat bend lines between first and second axial ends embedded in first and second axial end caps to provide a filter element.

20. The filter media and liner pleat block according to claim 15 comprising at least one layer of said mesh screen liner between said mating pleats.

21. The filter media and liner pleat block according to claim 15 comprising two layers of said mesh screen liner between said mating pleats, namely, a first layer of said mesh screen liner along said one of said mating pleats, and a second layer of said mesh screen liner along said other of said mating pleats.

22. The filter media and liner pleat block according to claim 21 comprising an extra layer of material between said first and second layers of mesh screen liner, said extra strip of material being melted and bonded to said filter media of said one and said other of said mating pleats such that said filter media of said one of said mating pleats is bonded to said filter media of said other of said mating pleats by said extra strip of material therebetween.

23. The filter media and liner pleat block according to claim 22 wherein said extra strip of material is an extra strip of filter media.

24. A filter media and liner pleat block produced by the method of claim 2, said filter media and liner pleat block comprising a layer of filter media and a mesh screen liner pleated along axially extending pleat bend lines and wrapped around a closed loop to mating pleats, said filter media having melted portions at said mating pleats to form a closed-loop-bonded said filter media and liner pleat block.
